(19) United States
(12) Patent Application Publication
(10) Pub. No.: US 2019/0012464 A1
(43) Pub. Date: Jan. 10, 2019

(54) METHOD AND DEVICE FOR ENSURING SECURITY OF FIRMWARE OF POS MACHINE

(71) Applicant: PAX COMPUTER TECHNOLOGY (SHENZHEN) CO., LTD., Shenzhen, Guanddong (CN)

(72) Inventor: Zhanqian YE, Shenzhen, Guangdong (CN)

(73) Assignee: Pax Computer Technology (Shenzhen) Co., Ltd., Shenzhen, Guangdong (CN)

(21) Appl. No.: 15/744,315

(22) PCT Filed: Aug. 1, 2017
(86) PCT No.: PCT/CN2017/095479

§ 371 Date: Sep. 27, 2018

(30) Foreign Application Priority Data
Jun. 6, 2017 (CN) 201710417430.7

(51) Int. Cl. G06F 21/57; G06F 21/60; G06Q 20/20

(52) U.S. Cl. CPC G06F 21/575; G06Q 20/206; G06F 21/602

(57) ABSTRACT

The present application is applicable to the technical field of terminals and provides a method and device for ensuring security of a firmware of a POS machine. The method includes: according to a CPU type, presetting a loading mode corresponding to the CPU type; and selecting, according to the loading mode, an embedded multi media card (eMMC) boot medium to load first-level boot firmware. Through the method, the loading from another boot medium that can be connected externally can be avoided, and the replacement or tampering of firmware in a POS machine through the boot medium is prevented, to ensure that the POS machine meets the security requirement.

### TECHNICAL FIELD

The present application relates to the technical field of terminals, and particularly to a method and device for ensuring security of a firmware of a point of sale (POS) machine and a terminal device.

### BACKGROUND

With the development of an electronic payment technology, financial POS machines are widely used in supermarkets, chain stores, hypermarkets, restaurants and other places as sales terminals with a non-cash settlement function. The POS machines based on an Android system and a smartphone hardware platform have good scalability and good user experience. Because the POS machines involve transactions of bank cards, there are high requirements on the security performance of the POS machines, and it needs to be ensured that important data therein, such as a secret key, is not stolen.

To ensure the security of a POS program in the POS machine and to prevent criminals from locking the POS program, existing POS machine manufacturers use a secure central processing unit (CPU) in the POS machine to ensure the firmware security through the boot of the secure CPU. However, the secure CPU is weak in performance, has fewer functions and is high in cost. A general-purpose CPU has a wide range of options and is generally more powerful in functions; however, the general-purpose CPU has no secure boot option. The use of the general-purpose CPU in the POS machine easily causes the firmware of the POS machine to be tampered with, and therefore the security requirement of the POS machine cannot be ensured.

### Technical Problem

In view of this, embodiments of the present application provide a method and device for ensuring security of a firmware of a POS machine and a terminal device, so as to solve the problem that the use of a general-purpose CPU in a POS machine easily causes the firmware of the POS machine to be tampered with, and therefore the security requirement of the POS machine cannot be ensured.

### Technical Solutions

A first aspect of the present application provides a method for ensuring security of a firmware of a POS machine, where the method for ensuring security of the firmware of the POS machine includes:

according to a CPU type, presetting a loading mode corresponding to the CPU type; and

selecting, according to the loading mode, an embedded multi media card (eMMC) boot medium to load first-level boot firmware.

A second aspect of the present application provides a device for ensuring security of a firmware of a POS machine, where the device for ensuring security of the firmware of the POS machine includes:

a setting unit, configured to preset a loading mode corresponding to a CPU type according to the CPU type; and

a loading unit, configured to select, according to the loading mode, an eMMC boot medium to load first-level boot firmware.

A third aspect of the present application provides a terminal device including a memory, a processor, and a computer program stored in the memory and executable on the processor, where when the processor executes the computer program, the steps of the method for ensuring security of the firmware of the POS machine according to the present application are implemented.

A fourth aspect of the present application provides a computer readable storage medium storing a computer program, where when the computer program is executed by a processor, the steps of the method for ensuring security of the firmware of the POS machine according to the present application are implemented.

### Beneficial Effects

Compared with the prior art, embodiments of the present application have the following beneficial effects: In the embodiments of the present application, according to a CPU type, a loading mode corresponding to the CPU type is preset; and an eMMC boot medium is selected according to the loading mode to load first-level boot firmware. Therefore, the loading from another boot medium that can be connected externally is avoided, and the replacement or tampering of firmware in a POS machine through the boot medium is prevented, to ensure that the POS machine meets the security requirement. Besides, as a general-purpose CPU can be of any type, it can be ensured that the system performance of the POS machine is not limited by the performance of a secure CPU. In addition, a secure CPU having lower performance can be selected as a coprocessor of the general-purpose CPU, to reduce cost.

### BRIEF DESCRIPTION OF DRAWINGS

To describe the technical solutions in the embodiments of the present application more clearly, the following briefly describes the accompanying drawings required for describing the embodiments or the prior art. Apparently, the accompanying drawings in the following description show merely some embodiments of the present application, and persons of ordinary skill in the art may still derive other accompanying drawings from these accompanying drawings without creative efforts.

FIG. 1 is an implementation flow chart of a method for ensuring security of a firmware of a POS machine according to an embodiment of the present application;

FIG. 2a is an implementation flow chart of another method for ensuring security of a firmware of a POS machine according to an embodiment of the present application;

FIG. 2b is a schematic diagram of setting an eMMC boot medium to a permanent write protection state according to an embodiment of the present application;

FIG. 3 is an implementation flow chart of still another method for ensuring security of a firmware of a POS machine according to an embodiment of the present application;

FIG. 4a is a structural block diagram of a device for ensuring security of a firmware of a POS machine according to an embodiment of the present application;

FIG. 4b is a structural block diagram of another device for ensuring security of a firmware of a POS machine according to an embodiment of the present application; and

FIG. 5 is a schematic diagram of an intelligent terminal according to an embodiment of the present application.

### DETAILED DESCRIPTION OF THE EMBODIMENTS

In the following description, for purposes of explanation and not limitation, specific details such as particular system architecture and techniques are set forth to provide a thorough understanding of embodiments of the present application. However, it shall be apparent to those skilled in the art that the present application may also be implemented in other embodiments that do not have these details. In other instances, detailed descriptions of well-known systems, devices, circuits, and methods are omitted so as not to obscure the description of the present application with unnecessary details.

To describe the technical solutions of the present application, the following uses specific embodiments for description.

### Embodiment 1

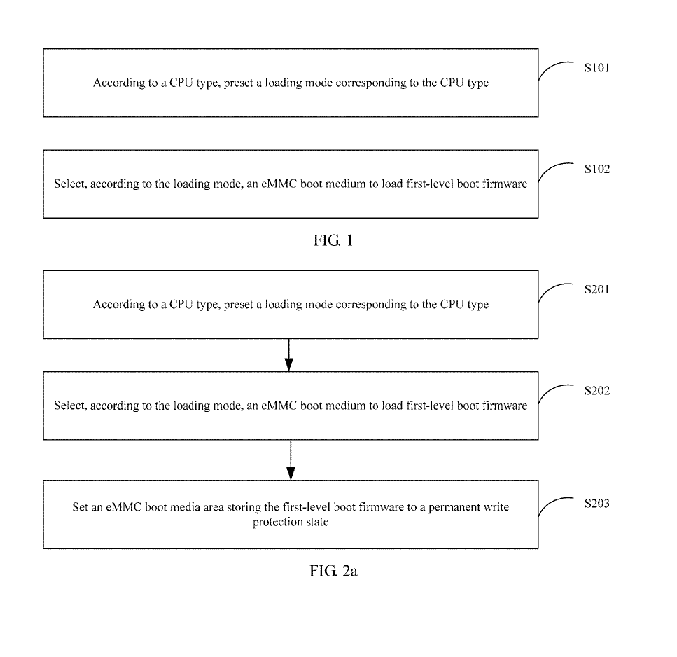

FIG. 1 shows a flow chart of a method for ensuring security of a firmware of a POS machine according to an embodiment of the present application, where the method is described in detail as follows:

Step S101: According to a CPU type, preset a loading mode corresponding to the CPU type.

Specifically, generally, a terminal device such as an Android device mainly includes firmware such as ROM Boot, First Boot, Boot, Kernel, and System, where the ROM Boot is firmware that is cured inside a CPU chip and cannot be modified. After the CPU boots, a program in the ROM Boot operates, to load the First Boot for operation; the First Boot is namely first-level boot firmware and is used to initialize the CPU, a memory and other devices, and load next-level firmware such as the Boot; the Boot is generally little kernel or uboot, and is responsible for loading the Kernel; the Kernel is a system kernel; and the System is an Android system. During the CPU booting, the booting starts from the ROM Boot in the CPU first. The ROM Boot selects a boot medium to load the First Boot. The boot medium usually available includes embedded multi media card (eMMC), SD card, USB, etc., and ROM Boots of different types of CPUs are different in modes of selecting a boot medium to load the First Boot. The eMMC is mainly for embedded memory standard specifications of mobile terminal products. One obvious advantage of the eMMC is the integration of a controller during encapsulation, and the controller provides a standard interface and manages a flash memory, so that mobile terminal manufacturers can focus on the rest of the product development.

For example, there is a type of CPU that has a fuse configuration, and this type of CPU selects a boot medium according to the configuration of fuses inside the CPU. The fuses inside the CPU are configured at a time and cannot be changed after being burned. There is a type of CPU that selects a boot medium according to boot pin configurations. When a system is powered up, the boot medium is selected based on the state of some specific external GPIOs. There is also a type of CPU that tries to load various boot media in rotation, and this type of CPU attempts to load the First Boot from some media in turn in a certain order. Therefore, in step S101, according to a CPU type, a loading mode corresponding to the CPU type is preset to load first-level boot firmware.

Step S102: Select, according to the loading mode, an eMMC boot medium to load the first-level boot firmware.

Specifically, according to the loading mode selected in step S101, the eMMC boot medium is selected to load the first-level boot firmware. In this embodiment of the present application, the first-level boot firmware First Boot is pre-placed in the eMMC. The First Boot is loaded from the eMMC no matter what type of CPU is selected and no matter how the ROM Boot loads the First Boot, so as to avoid the loading from another boot medium that can be connected externally, and to prevent the replacement or tampering of firmware in a POS machine through the boot medium.

Further, due to different types of CPUs, the modes of loading the First Boot are different. Therefore, when the type of the CPU is to select the boot medium for loading according to a fuse configuration state, step S102 specifically includes:

step A1 of setting fuses to load the first-level boot firmware from the eMMC boot medium.

Specifically, when the type of the CPU is to provide the fuses to control the boot mode, in this embodiment of the present application, the fuses are used to lock the CPU to load the first-level boot firmware from the eMMC only. When the system is powered up, the ROM Boot operates, and the ROM Boot reads the state of the fuses inside the CPU and fixedly chooses to load the First Boot from the eMMC. Because the fuses cannot be changed after being burned at a time, in this embodiment of the present application, the CPU can load the First Boot only from the eMMC, the boot mode cannot be changed, and accordingly the firmware cannot be replaced.

Optionally, when the type of the CPU is to select the boot medium for loading according to a pin configuration state, the step S102 specifically includes:

step B1 of setting the level of a boot pin to a specified level, so that the CPU fixedly loads the first-level boot firmware from the eMMC boot medium.

Specifically, when the type of the CPU is to select the boot medium for loading according to the pin configuration state, the level of the boot pin is set to a specified level, and a start-up source is set to select a state of a GPIO. After the system is powered up, the ROM Boot operates, and the ROM Boot reads the start-up source to select the state of the GPIO. The CPU fixedly loads the First Boot only from the eMMC. The boot mode cannot be changed, and therefore the firmware cannot be replaced.

Further, the boot pin is placed in a hardware security area, to prevent the level of the boot pin from being altered by external attack. The hardware security area is a special hardware area of the POS device. Devices in this area are protected by a MESH cable (a network cable) and a PCB wallboard. The MESH cable and the PCB wallboard are internally connected to sensors of the secure CPU. When external physical attack occurs, the MESH cable or a PCB wallboard circuit is damaged, so that the sensors of the secure CPU are triggered, and thus sensitive information stored in the POS device, such as a secret key, is removed.

Optionally, when the type of the CPU is to select the boot medium for loading according to a rotation attempt mode, the step S102 specifically includes:

step C1 of shielding boot media other than the eMMC boot medium, thereby forcing the CPU to load the first-level boot firmware only from the eMMC boot medium.

Specifically, when the type of CPU is to select the boot medium for loading according to the rotation attempt mode, boot media other than the eMMC are shielded on hardware to force the CPU to boot from the eMMC only.

For example, on a CPU that attempts to load the First Boot from the USB first and then load the First Boot from the eMMC, during booting, an analog switch is used to disconnect the USB of the CPU from an external USB port, to prevent the CPU from loading the First Boot from the USB, so as to force the CPU to boot only from the eMMC, and to ensure that the firmware cannot be replaced. After the First Boot operates, the analog switch is switched on, so that the USB of the CPU is connected to the external USB port, and in this case, the USB port can be used normally.

In this embodiment of the present application, according to the CPU type, the loading mode corresponding to the CPU type is preset, for example, the boot medium is selected for loading according to the fuse configuration state, or the boot medium is selected for loading according to the pin configuration state, or the boot medium is selected for loading according to the rotation attempt mode; and then according to the loading mode, it is fixedly chosen to load the first-level boot firmware from the eMMC boot medium. Therefore, the loading from another boot medium that can be connected externally is avoided, and the replacement or tampering of firmware in a POS machine through the boot medium is prevented, to ensure that the POS machine can meet the security requirement. Besides, as a general-purpose CPU can be of any type, it is ensured that the system performance of the POS machine is not limited by the performance of a secure CPU. In addition, a secure CPU having lower performance can be selected as a coprocessor of the general-purpose CPU, to reduce cost.

### Embodiment 2

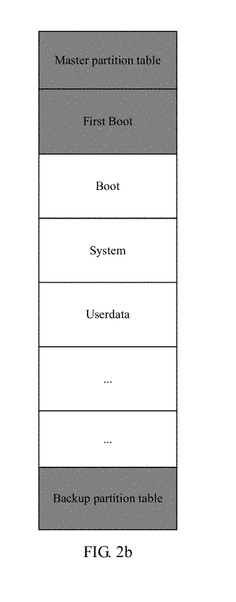

FIG. 2a shows a flow chart of a method for ensuring security of a firmware of a POS machine according to the first embodiment of the present application, where the method is described in detail as follows:

Step S201: According to a CPU type, preset a loading mode corresponding to the CPU type.

ROM Boots of different types of CPUs are different in modes of selecting a boot medium to load the First Boot. For example, there is a type of CPU that has a fuse configuration, and this type of CPU selects a boot medium according to the configuration of fuses inside the CPU. The fuses inside the CPU are configured at a time and cannot be changed after being burned. There is a type of CPU that selects a boot medium according to boot pin configurations. When a system is powered up, the boot medium is selected based on the state of some specific external GPIOs. There is also a type of CPU that tries to load various boot media in rotation, and this type of CPU attempts to load the First Boot from some media in turn in a certain order. Therefore, in step S101, according to a CPU type, a loading mode corresponding to the CPU type is preset to load first-level boot firmware.

Step S202: Select, according to the loading mode, an eMMC boot medium to load the first-level boot firmware.

Specifically, in this embodiment of the present application, all types of CPUs fixedly choose to load the first-level boot firmware from the eMMC boot medium.

In this embodiment, for specific steps in steps S201 to S202, refer to step S101 to step S102 in Embodiment 1, and details are not described herein again.

Step S203: Set an eMMC boot medium area storing the first-level boot firmware to a permanent write protection state.

Further, in this embodiment of the present application, the first-level boot firmware is stored in the eMMC, and a method for setting a related area of the eMMC boot medium to permanent write protection includes:

step D1 of setting eMMC (EXT_CSD[171] bit 2) US_PERM_WP_EN to 1; and

step D2 of executing a SET_WRITE_PROT (CMD28) command.

Specifically, in this embodiment of the present application, by setting the eMMC (EXT_CSD[171] bit 2) US_PERM_WP_EN to 1 and then executing the SET_WRITE_PROT (CMD28) command, permanent write protection operation is performed on the eMMC.

By forcing the CPU to load the First Boot from the eMMC in step S202, ROM Boot searches for the start address and size of the First Boot partition according to information in an eMMC partition table, and loads the First Boot into a memory for execution. Through the eMMC permanent write protection command, permanent write protection operation is performed on a master partition table, a backup partition table, and an area where the First Boot is located. As shown in FIG. 2b, permanent write protection operation is performed on gray areas in the figure, and firmware in these areas can no longer be replaced or tampered with, thus ensuring the security of the firmware.

In this embodiment of the present application, according to the CPU type, the loading mode corresponding to the CPU type is preset; and then according to the loading mode, it is fixedly chosen to load the first-level boot firmware from the eMMC boot medium. Therefore, the loading from another boot medium that can be connected externally is avoided, and the replacement or tampering of firmware in a POS machine through the boot medium is prevented, to ensure that the POS machine can meet the security requirement. By setting the related area of the eMMC boot medium storing the first-level boot firmware to a permanent write protection state, it is further ensured that the firmware in the POS machine is prevented from being replaced or tampered with. Besides, as a general-purpose CPU can be of any type, it can be ensured that the system performance of the POS machine is not limited by the performance of a secure CPU. In addition, a secure CPU having lower performance can be selected as a coprocessor of the general-purpose CPU, to reduce cost.

### Embodiment 3

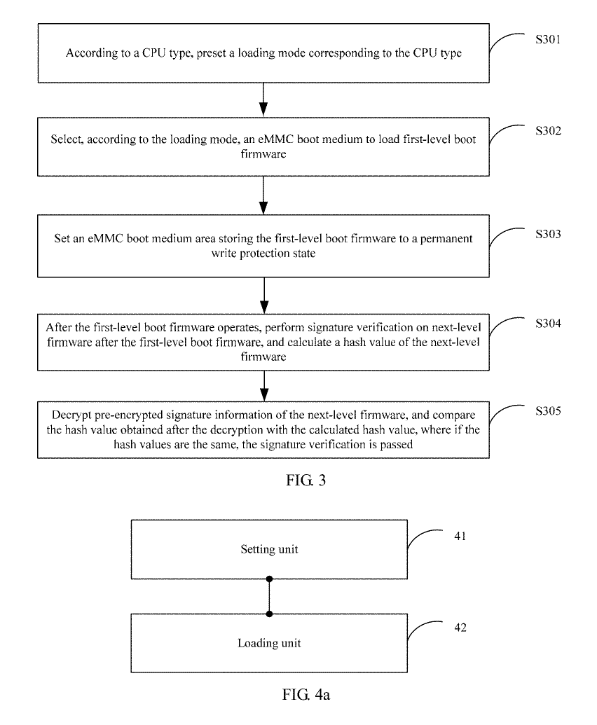

FIG. 3 shows a flow chart of a method for ensuring security of a firmware of a POS machine according to the first embodiment of the present application, where the method is described in detail as follows:

Step S301: According to a CPU type, preset a loading mode corresponding to the CPU type.

Step S302: Select, according to the loading mode, an eMMC boot medium to load first-level boot firmware.

Step S303: Set an eMMC boot medium area storing the first-level boot firmware to a permanent write protection state.

In this embodiment, for specific steps in step S301 to step S303, refer to step S201 to step S203 in Embodiment 2, and details are not described herein again.

Step S304: After the first-level boot firmware operates, perform signature verification on the next-level firmware after the first-level boot firmware, and calculate a hash value of the next-level firmware.

In this embodiment of the present application, after the first-level boot firmware operates, signature verification needs to be performed on the next-level firmware after the first-level boot firmware, and the hash value of the next-level firmware needs to be calculated.

Step S305: Decrypt pre-encrypted signature information of the next-level firmware, and compare the hash value obtained after the decryption with the calculated hash value, and if the hash values are the same, the signature verification is passed.

Further, in this embodiment of the present application, the next-level firmware after the first-level boot firmware is encrypted in advance, e.g., a 2048-bit RSA secret key encryption algorithm is used to encrypt the next-level firmware, where the method specifically includes:

step E1 of calculating the hash value of the next-level firmware after the first-level boot firmware; and

step E2 of encrypting the hash value of the next-level firmware by using a private key, to obtain the signature information and form the encrypted next-level firmware.

It should be noted that, in this embodiment of the present application, another encryption mode may be used to encrypt the next-level firmware after the first-level boot firmware, which is not limited herein.

In this embodiment of the present application, the pre-encrypted signature information is decrypted by using a public key to obtain a decrypted hash value, and the hash value obtained after the decryption is compared with the hash value obtained by calculating the next-level firmware in step S304. If the hash values are the same, it means that the next-level firmware has not been tampered with, and the signature verification is passed. If the hash values are different, it indicates that the next-level firmware may have been tampered with, and the signature verification fails.

In this embodiment of the present application, according to the CPU type, the loading mode corresponding to the CPU type is preset; and then according to the loading mode, it is fixedly chosen to load the first-level boot firmware from the eMMC boot medium. Therefore, the loading from another boot medium that can be connected externally is avoided, and the replacement or tampering of firmware in a POS machine through the boot medium is prevented, to ensure that the POS machine can meet the security requirement. By setting the related area of the eMMC boot medium storing the first-level boot firmware to a permanent write protection state, it is further ensured that the firmware in the POS machine is prevented from being replaced or tampered with. The foregoing method ensures that the first-level boot firmware cannot be tampered with. After the first-level boot firmware runs, signature verification is performed on the next-level firmware after the first-level boot firmware. The hash value of the next-level firmware is calculated, the pre-encrypted signature information of the next-level firmware is decrypted, and the hash value obtained after the decryption is compared with the calculated hash value. If the hash values are the same, the signature verification is passed. That is, by performing signature verification on the next-level firmware after the first-level boot firmware, it is ensured that the next-level firmware is not tampered with, and the performance security of the POS machine is further improved. Besides, as a general-purpose CPU can be of any type, it can be ensured that the system performance of the POS machine is not limited by the performance of a secure CPU. In addition, a secure CPU having lower performance can be selected as a coprocessor of the general-purpose CPU, to reduce cost.

It should be understood that, the sequence numbers of the steps in the foregoing embodiments does not mean the order of execution. The execution sequence of each process should be determined by its function and inherent logic, and should not impose any limitation to the implementation processes of the embodiments of the present application.

### Embodiment 4

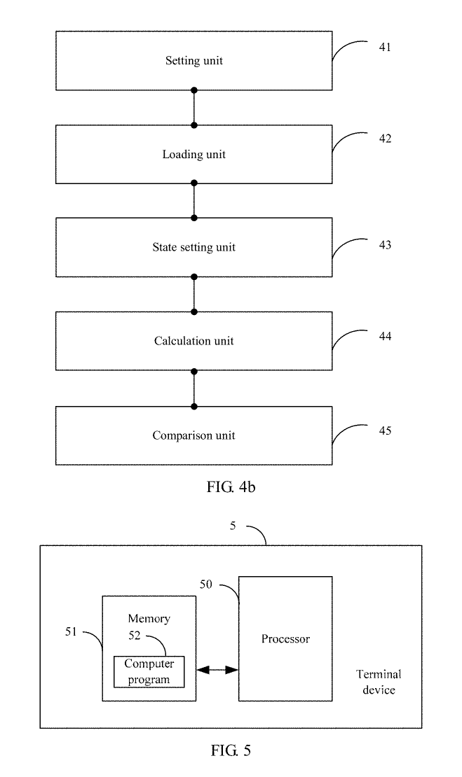

Corresponding to the method for ensuring security of the firmware of the POS machine described in the foregoing embodiment, FIG. 4a shows a structural block diagram of a device for ensuring security of a firmware of a POS machine according to an embodiment of the present application, where the device is applicable to an intelligent terminal, and the intelligent terminal may include a mobile device that communicates with one or more core networks via a radio access network (RAN), such as a POS machine. For convenience in description, only the parts related to the embodiments of the present application are shown.

Referring to FIG. 4a, the device for ensuring security of the firmware of the POS machine includes a setting unit 41 and a loading unit 42, where:

the setting unit 41 is configured to preset a loading mode corresponding to a CPU type according to the CPU type.

Specifically, generally, a terminal device such as an Android device mainly includes firmware such as ROM Boot, First Boot, Boot, Kernel, and System, where the ROM Boot is firmware that is cured inside a CPU chip and cannot be modified. After the CPU boots, a program in the ROM Boot operates, to load the First Boot for operation; the First Boot is namely first-level boot firmware and is used to initialize the CPU, a memory and other devices, and load next-level firmware such as the Boot; the Boot is generally little kernel or uboot, and is responsible for loading the Kernel; the Kernel is a system kernel; and the System is an Android system. During the CPU booting, the booting starts from the ROM Boot in the CPU first. The ROM Boot selects boot medium to load the First Boot. The boot medium usually available includes eMMC, SD card, USB, etc., and ROM Boots of different types of CPUs are different in modes of selecting boot medium to load the First Boot.

For example, there is a type of CPU that has a fuse configuration, and this type of CPU selects a boot medium according to the configuration of fuses inside the CPU. The fuses inside the CPU are configured at a time and cannot be changed after being burned. There is a type of CPU that selects a boot medium according to boot pin configurations. When a system is powered up, the boot medium is selected based on the state of some specific external GPIOs. There is also a type of CPU that tries to load various boot media in rotation, and this type of CPU attempts to load the First Boot from some media in turn in a certain order.

The loading unit 42 is configured to select, according to the loading mode, an eMMC boot medium to load the first-level boot firmware.

Specifically, in this embodiment of the present application, the first-level boot firmware First Boot is pre-placed in the eMMC. The First Boot is loaded from the eMMC no matter what type of CPU is selected and no matter how the ROM Boot loads the First Boot.

Optionally, when the type of the CPU is to select the boot medium for loading according to the fuse configuration state, the loading unit 42 includes:

a fuse setting module, configured to set fuses to load the first-level boot firmware from the eMMC boot medium.

Specifically, when the type of the CPU is to provide the fuses to control the boot mode, in this embodiment of the present application, the fuses are used to lock the CPU to load the first-level boot firmware from the eMMC only. When the system is powered up, the ROM Boot operates, and the ROM Boot reads the state of the fuses inside the CPU and fixedly chooses to load the First Boot from the eMMC. Because the fuses cannot be changed after being burned at a time, in this embodiment of the present application, the CPU can load the First Boot only from the eMMC, the boot mode cannot be changed, and accordingly the firmware cannot be replaced.

Optionally, when the type of the CPU is to select the boot medium for loading according to a pin configuration state, the loading unit 42 includes:

a pin level setting module, configured to set the level of a boot pin to a specified level, so that the CPU fixedly loads the first-level boot firmware from the eMMC boot medium.

Specifically, when the type of the CPU is to select the boot medium for loading according to the pin configuration state, the level of the boot pin is set to a specified level, and a start-up source is set to select a state of a GPIO. After the system is powered up, the ROM Boot operates, and the ROM Boot reads the start-up source to select the state of the GPIO. The CPU fixedly loads the First Boot only from the eMMC. The boot mode cannot be changed, and therefore the firmware cannot be replaced.

Further, the boot pin is placed in a hardware security area, to prevent the level of the boot pin from being altered by external attack. The hardware security area is a special hardware area of the POS device. Devices in this area are protected by a MESH cable (a network cable) and a PCB wallboard. The MESH cable and the PCB wallboard are internally connected to sensors of the secure CPU. When external physical attack occurs, the MESH cable or a PCB wallboard circuit is damaged, so that the sensors of the secure CPU are triggered, and thus sensitive information stored in the POS device, such as a secret key, is removed.

Optionally, when the type of the CPU is to select the boot medium for loading according to a rotation attempt mode, the loading unit 42 includes:

a shielding module, configured to shield boot media other than the eMMC boot medium, thereby forcing the CPU to load the first-level boot firmware only from the eMMC boot medium.

Specifically, when the type of CPU is to select the boot medium for loading according to the rotation attempt mode, boot media other than the eMMC are shielded on hardware to force the CPU to boot from the eMMC only.

For example, on a CPU that attempts to load the First Boot from the USB first and then load the First Boot from the eMMC, during booting, an analog switch is used to disconnect the USB of the CPU from an external USB port, to prevent the CPU from loading the First Boot from the USB, so as to force the CPU to boot only from the eMMC, and to ensure that the firmware cannot be replaced. After the First Boot operates, the analog switch is switched on, so that the USB of the CPU is connected to the external USB port, and in this case, the USB port can be used normally.

Further, as shown in FIG. 4b, the device for ensuring security of the firmware of the POS machine further includes:

a state setting unit 43, configured to set an eMMC boot medium area storing the first-level boot firmware to a permanent write protection state.

Specifically, in this embodiment of the present application, by setting eMMC (EXT_CSD[171] bit 2) US_PERM_WP_EN to 1 and then executing a SET_WRITE_PROT (CMD28) command, permanent write protection operation is performed on the eMMC.

A calculation unit 44 is configured to perform signature verification on next-level firmware after the first-level boot firmware after the first-level boot firmware operates, and calculate a hash value of the next-level firmware.

A comparison unit 45 is configured to decrypt pre-encrypted signature information of the next-level firmware, and compare the hash value obtained after the decryption with the calculated hash value. If the hash values are the same, the signature verification is passed.

Further, in this embodiment of the present application, the next-level firmware after the first-level boot firmware is encrypted in advance, e.g., a 2048-bit RSA secret key encryption algorithm is used to encrypt the next-level firmware, and the encryption method is not limited herein.

In this embodiment of the present application, according to the CPU type, the loading mode corresponding to the CPU type is preset; and then according to the loading mode, it is fixedly chosen to load the first-level boot firmware from the eMMC boot medium. Therefore, the loading from another boot medium that can be connected externally is avoided, and the replacement or tampering of firmware in a POS machine through the boot medium is prevented, to ensure that the POS machine can meet the security requirement. By setting the related area of the eMMC boot medium storing the first-level boot firmware to a permanent write protection state, it is further ensured that the firmware in the POS machine is prevented from being replaced or tampered with. The foregoing method ensures that the first-level boot firmware cannot be tampered with. After the first-level boot firmware runs, signature verification is performed on the next-level firmware after the first-level boot firmware. The hash value of the next-level firmware is calculated, the pre-encrypted signature information of the next-level firmware is decrypted, and the hash value obtained after the decryption is compared with the calculated hash value. If the hash values are the same, the signature verification is passed. That is, by performing signature verification on the next-level firmware after the first-level boot firmware, it is ensured that the next-level firmware is not tampered with, and the performance security of the POS machine is further improved. Besides, as a general-purpose CPU can be of any type, it can be ensured that the system performance of the POS machine is not limited by the performance of a secure CPU. In addition, a secure CPU having lower performance can be selected as a coprocessor of the general-purpose CPU, to reduce cost.

### Embodiment 5

FIG. 5 is a schematic diagram of a terminal device according to an embodiment of the present application. As shown in FIG. 5, the terminal device 5 in this embodiment includes a processor 50, a memory 51, and a computer program 52 stored in the memory 51 and executable on the processor 50, where the computer program 52 is for example a program for ensuring security of a firmware of a POS machine. When the processor 50 executes the computer program 52, the steps in the foregoing method embodiments for ensuring security of a firmware of a POS machine are implemented, for example, steps 101 to 102 shown in FIG. 1. Alternatively, when the processor 50 executes the computer program 52, functions of each module/unit in the foregoing device embodiments are implemented, for example, the functions of units 41 to 45 shown in FIG. 4b.

Illustratively, the computer program 52 may be divided into one or more modules/units, which are stored in the memory 51 and executed by the processor 50 to complete this application. The one or more modules/units may be a series of computer program instruction segments capable of fulfilling a specific function, and the instruction segments are used to describe the execution of the computer program 52 in the terminal device 5. For example, the computer program 52 may be divided into a setting unit, a loading unit, a state setting unit, a calculation unit, and a comparison unit. Specific functions of each unit are as follows:

The setting unit is configured to preset a loading mode corresponding to a CPU type according to the CPU type.

The loading unit is configured to select, according to the loading mode, an eMMC boot medium to load first-level boot firmware.

The state setting unit is configured to set an eMMC boot medium area storing the first-level boot firmware to a permanent write protection state.

The calculation unit is configured to perform signature verification on next-level firmware after the first-level boot firmware after the first-level boot firmware operates, and calculate a hash value of the next-level firmware.

The comparison unit is configured to decrypt pre-encrypted signature information of the next-level firmware, and compare the hash value obtained after the decryption with the calculated hash value. If the hash values are the same, the signature verification is passed.

The terminal device 5 may be a computing device such as a desktop computer, a notebook, a palmtop computer and a cloud server, and may also be a financial POS machine. The terminal device may include, but is not limited to, the processor 50 and the memory 51. It can be understood by those skilled in the art that FIG. 5 is only an example of the terminal device 5 and does not constitute a limitation on the terminal device 5, and may include more or fewer components than those shown in the figure, or a combination of some components or different components. For example, the terminal device may further include an input/output device, a network access device, a bus, etc.

The processor 50 may be a central processing unit (CPU), and may also be another general-purpose processor, a digital signal processor (DSP), an application specific integrated circuit (ASIC), a field-programmable gate array (FPGA) or other programmable logic devices, discrete gates or transistor logic devices, discrete hardware components, etc. The general-purpose processor may be a microprocessor or the processor may also be any conventional processor, etc.

The memory 51 may be an internal storage unit of the terminal device 5, for example, a hard disk or a memory of the terminal device 5. The memory 51 may also be an external storage device of the terminal device 5, for example, a plug-in hard disk, a smart media card (SMC), a secure digital (SD) card, a flash card, etc., which is arranged on the terminal device 5. Further, the memory 51 may include both an internal storage unit of the terminal device 5 and an external storage device. The memory 51 is configured to store the computer program and other programs and data required by the terminal device. The memory 51 may also be configured to temporarily store data that has been or will be output.

It is clearly understood by those skilled in the art that, for the convenience and simplicity of the description, only the division of the foregoing functional units and modules is described by way of example. In practical applications, the foregoing functions may be allocated to be completed by different functional units and modules as required, that is, the internal structure of the device is divided into different functional units or modules, to complete all or some of the functions described above. The functional units and modules in the embodiments may be integrated in one processing unit, or each unit may exist separately and physically, or two or more units may be integrated in one unit, and the foregoing integrated unit may be implemented in the hardware form, and may also be implemented in the form of software functional unit. In addition, specific names of each functional unit and module are merely for the convenience of distinguishing each other and are not intended to limit the protection scope of the present application. For the specific working process of the units and modules in the foregoing system, reference may be made to the corresponding processes in the foregoing method embodiments, and details are not described herein again.

In the foregoing embodiments, the description of each embodiment has a focus, and for the parts that are not described in detail or recorded in one embodiment, reference may be made to the related descriptions in other embodiments.

Those of ordinary skill in the art may be aware that, the units and algorithm steps of each example described in combination with the embodiments disclosed herein may be implemented by electronic hardware or a combination of computer software and electronic hardware. Whether these functions are implemented by hardware or software depends on the specific application and design constraints of the technical solutions. Those skilled in the art may use different methods to implement the described functions for each particular application, but such implementation should not be considered as beyond the scope of the present application.

In the embodiments provided by the present application, it should be understood that the disclosed device and method may be implemented in other manners. For example, the system embodiments described above are merely exemplary. For example, the division of modules or units is merely logical function division and may be other division in actual implementation. For example, a plurality of units or components may be combined or may be integrated into another system, or some features may be ignored or not performed. In addition, the mutual coupling or direct coupling or communication connection shown or discussed may be indirect coupling or communication connection through some interfaces, devices or units, and may be implemented in electrical, mechanical or other forms.

The units described as separate components may or may not be physically separated. The components displayed as units may or may not be physical units, that is, the components may be located in one place or may also be distributed to multiple network units. Some or all of the units may be selected according to actual needs to achieve the objectives of the solution in the embodiment.

In addition, the functional units in the embodiments of the present application may be integrated into one processing unit, or each unit may exist alone physically, or two or more units may be integrated in one unit. The above-mentioned integrated unit can be implemented in the form of hardware or in the form of a software functional unit.

When the integrated unit is implemented in the form of a software functional unit and is sold or used as an independent product, the integrated unit may be stored in a computer readable storage medium. Based on this understanding, all or part of the processes in the method for implementing the embodiments of the present application may also be implemented by instructing relevant hardware by using a computer program, which may be stored in a computer readable storage medium, where when the computer program is executed by the processor, the steps of the foregoing method embodiments may be implemented. The computer program includes computer program code, which may be in source code form, object code form, executable file form or some intermediate form, etc. The computer readable medium may include any entity or device capable of carrying the computer program code, a recording medium, a USB flash disk, a mobile hard disk, a magnetic disk, an optical disc, a computer memory, a read-only memory (ROM), a random access memory (RAM), electrical carrier signals, telecommunications signals and a software distribution medium, etc. It should be noted that the content contained in the computer readable medium may be appropriately increased or decreased according to the requirements of legislation and patent practice in jurisdictions. For example, in some jurisdictions, according to legislation and patent practice, the contents of a computer readable medium do not include electrical carrier signals and telecommunication signals.

The foregoing embodiments are merely intended for describing the technical solutions of the present application, but not for limiting the present application. Although the present application is described in detail with reference to the foregoing embodiments, it should be understood by those skilled in the art that they can still modify the technical solutions recorded in the above-mentioned embodiments, or equivalently replace part of technical features therein; these modifications or replacements do not make the essence of the corresponding technical solutions depart from the spirit and scope of the technical solutions of the embodiments of the present application, and should be included in the protection scope of the present application.

1. A method for ensuring security of a firmware of a POS machine, comprising:
according to a CPU type, presetting a loading mode corresponding to the CPU type; and
selecting, according to the loading mode, an eMMC boot medium to load first-level boot firmware.

2. The method of claim 1, wherein when the type of the CPU is to select the boot medium for loading according to a fuse configuration state, the selecting, according to the loading mode, the eMMC boot medium to load first-level boot firmware comprises:
setting fuses to load the first-level boot firmware from the eMMC boot medium.

3. The method of claim 1, wherein when the type of the CPU is to select the boot medium for loading according to a pin configuration state, the selecting, according to the loading mode, the eMMC boot medium to load first-level boot firmware comprises:
setting the level of a boot pin to a specified level, so that the CPU fixedly loads the first-level boot firmware from the eMMC boot medium.

4. The method of claim 1, wherein when the type of the CPU is to select the boot medium for loading according to a rotation attempt mode, the selecting, according to the loading mode, the eMMC boot medium to load first-level boot firmware comprises:
shielding boot media other than the eMMC boot medium, so as to force the CPU to load the first-level boot firmware only from the eMMC boot medium.

5. The method of claim 1, wherein the method for ensuring security of the firmware of the POS machine further comprises:
setting an eMMC boot medium area storing the first-level boot firmware to a permanent write protection state.

6. The method of claim 1, wherein the method for ensuring security of the firmware of the POS machine further comprises:
after the first-level boot firmware operates, performing signature verification on next-level firmware after the first-level boot firmware, and calculating a hash value of the next-level firmware; and
decrypting pre-encrypted signature information of the next-level firmware, and comparing the hash value obtained after the decryption with the calculated hash value, wherein if the hash values are the same, the signature verification is passed.

7. A device for ensuring security of a firmware of a POS machine, comprising:
a setting unit, configured to preset a loading mode corresponding to a CPU type according to the CPU type; and
a loading unit, configured to select, according to the loading mode, an eMMC boot medium to load first-level boot firmware.

8. The device of claim 7, wherein the device for ensuring security of the firmware of the POS machine further comprises:
a state setting unit, configured to set an eMMC boot medium area storing the first-level boot firmware to a permanent write protection state;
a calculation unit, configured to perform signature verification on next-level firmware after the first-level boot firmware after the first-level boot firmware operates, and calculate a hash value of the next-level firmware; and
a comparison unit, configured to decrypt pre-encrypted signature information of the next-level firmware, and compare the hash value obtained after the decryption with the calculated hash value, wherein if the hash values are the same, the signature verification is passed; and
the loading unit further comprises:
a fuse setting module, configured to set fuses to load the first-level boot firmware from the eMMC boot medium;
a pin level setting module, configured to set the level of a boot pin to a specified level, so that the CPU fixedly loads the first-level boot firmware from the eMMC boot medium; and
a shielding module, configured to shield boot media other than the eMMC boot medium, so as to force the CPU to load the first-level boot firmware only from the eMMC boot medium.

9. A terminal device, comprising a memory, a processor, and a computer program stored in the memory and executable on the processor, wherein when the processor executes the computer program, the steps of the method for ensuring security of the firmware of the POS machine of claim 1 are implemented.

10. (canceled)
